(19) United States
(12) Patent Application Publication
(10) Pub. No.: US 2019/0138330 A1
(43) Pub. Date: May 9, 2019

(54) Task Processing Method and Device

(71) Applicant: Alibaba Group Holding Limited, Grand Cayman (KY)

(72) Inventor: Nan Wu, Beijing (CN)

(73) Assignee: Alibaba Group Holding Limited

(21) Appl. No.: 16/171,273

(22) Filed: Oct. 25, 2018

(30) Foreign Application Priority Data
Nov. 8, 2017 (CN) 201711092758.2

(51) Int. Cl. G06F 9/451; G06F 17/30; G06F 9/48; G10L 15/22

(52) U.S. Cl. CPC G06F 9/453; G06F 17/30044; G10L 25/84; G06F 9/4843; G10L 15/22; G06F 17/30041

(57) ABSTRACT

Task processing method and device are provided. The method includes initiating a multimedia inquiry to a target object; obtaining response data in response to the multimedia inquiry; iteratively initiating one or more inquiries until data needed for performing a pre-designated task is obtained; and initiating the pre-designated task based on the needed data. Using the above solutions, existing technical problems of a poor user experience due to the need of a user to actively wake up or actively initiate an interaction can be solved, thus effectively achieving an enhancement in the user experience.

### CROSS REFERENCE TO RELATED PATENT APPLICATIONS

This application claims priority to Chinese Patent Application No. 201711092758.2, filed on 8 Nov. 2017, entitled “Task Processing Method and Device,” which is hereby incorporated by reference in its entirety.

### TECHNICAL FIELD

The present disclosure belongs to the technical field of human-machine interactions, and particularly to task processing methods and devices.

### BACKGROUND

With the continuous development of voice recognition technologies, an increasing number of voice smart devices has been developed and used. Currently, voice interaction methods generally adopt a question-and-answer approach, and generally a user initiates communication content. For example, a user asks: What is the weather today? A voice smart device answers: Today's weather is cloudy, 18 to 26° C. In other words, a user needs to actively trigger a voice interaction, i.e., a person need to play a leading role to conduct voice interactions.

However, such approach that a user needs to trigger and lead the use of a certain device is often not very user-friendly. This is especially true for some devices that are not frequently used by users and have insufficient time for learning. If a user performs guiding, it is more cumbersome to implement and have a poor experience.

No effective solution has yet been proposed for the above problems.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure aims to provide a task processing method and a device thereof, which can achieve the purpose of actively initiating an inquiry without guiding the device.

A task processing method and a device thereof provided by the present disclosure are implemented as follows.

A task processing method includes initiating a multimedia inquiry to a target object; obtaining reply data in response to the multimedia inquiry; iteratively initiating one or more inquiries until data needed for performing a pre-designated task is obtained; and initiating the pre-designated task based on the needed data.

A task processing device comprising a processor and memory configured to store processor executable instructions, the processors executing the instructions to implement initiating a multimedia inquiry to a target object; obtaining reply data in response to the multimedia inquiry; iteratively initiating the inquiry until data needed for performing a pre-designated task is obtained; and initiating the pre-designated task based on the needed data.

A computer readable storage media having computer instructions stored thereon, the instructions that, when executed, implement the above method.

In the task processing method and device provided by the present disclosure, the device proactively initiates an inquiry and iteratively initiates the inquiry until data needed for performing a predetermined task is obtained, thereby providing a proactive task processing method. The method can solve existing technical problems of a poor user experience due to the need of a user to actively wake up or actively initiate an interaction, and thus effectively achieve an enhancement in the user experience.

### BRIEF DESCRIPTION OF THE DRAWINGS

In order to describe technical solutions in the embodiments of the present disclosure more clearly, accompanying drawings that are needed for describing the embodiments or the existing technologies are briefly described herein. The drawings described as follows merely represent some embodiments recorded in the present disclosure. One of ordinary skill in the art can also obtain other drawings based on these accompanying drawings without making any creative effort.

FIG. 1 is a schematic structural diagram of a human-machine interaction system in accordance with the embodiments of the present disclosure.

FIG. 2 is a schematic diagram of a logical implementation of a human-computer interaction scenario in accordance with the embodiments of the present disclosure.

FIG. 3 is a schematic diagram of a predetermined location area in accordance with the embodiments of the present disclosure.

FIG. 4 is a diagram of a working scene of a smart coffee vending machine in accordance with the embodiments of the present disclosure.

FIG. 5 is diagram of another working scene of a smart coffee vending machine in accordance with the embodiments of the present disclosure.

FIG. 6 is a flowchart of a human-computer interaction that is actively triggered by a device in accordance with the embodiments of the present disclosure.

FIG. 7 is a schematic diagram of a coffee inquiry and purchase process associated with human-computer interactions that are actively triggered by a device in accordance with the embodiments of the present disclosure.

FIG. 8 is a method flowchart of a task processing method in accordance with the embodiments of the present disclosure.

FIG. 9 is a schematic structural diagram of a terminal device in accordance with the embodiments of the present disclosure.

FIG. 10 is a structural block diagram of a task processing apparatus in accordance with the embodiments of the present disclosure.

FIG. 11 is a schematic structural diagram of a centralized deployment mode in accordance with the embodiments of the present disclosure.

FIG. 12 is a schematic structural diagram of a large centralized and small dual active deployment mode in accordance with the embodiments of the present disclosure.

### DETAILED DESCRIPTION

In order to enable one skilled in the art to understand the technical solutions of the present disclosure in a better manner, the technical solutions of the embodiments of the present disclosure are described clearly and comprehensively in conjunction with the accompanying drawings of the embodiments of the present disclosure. Apparently, the described embodiments merely represent merely and not all of the embodiments of the present disclosure. Based on the embodiments in the present disclosure, all other embodiments obtained by one of ordinary skill in the art without making any creative effort should fall in the scope of protection of the present disclosure.

Currently, when conducting a voice interaction with an intelligent voice device, a user actively triggers to perform the voice interaction in general. For example, a user buys coffee at a counter. If a vending machine is set up at the counter, the user is generally required to actively interact therewith. The user says, “I want a cappuccino”, and such device answers “OK, a cup of cappuccino”.

In other words, the user is required to perform triggering. In many occasions, this type of requiring a user to actively perform triggering obviously leads to a poor user experience. Especially in the service industry, the user experience is better when a device initiates a dialogue. For example, given the same example which a user buys coffee at a counter as above, if a vending machine initiates a conversation, saying “Hello, what type of coffee do you want?”, for example, the user answers “A cup of cappuccino.” This kind of communications can effectively improve the user experience, and the intelligence of the vending machine can be effectively improved. For another example, a user intends to purchase a subway ticket in front of a device that sells subway tickets. If the user actively triggers a purchase process, he/she often does not know how to start. This is especially true for users who use the device for the first time, and do not know how to trigger, or how to inquire, etc.

Accordingly, considering that a task processing mode can be provided and a device initiates a dialogue, i.e., a proactive interaction mode initiated by the device, this can also avoid the problem that a user does not know how to ask the device. In this proactive interaction mode, the device can ask questions to the user, and the device dominates and guides the entire conversation process, thereby reducing the difficulties of use.

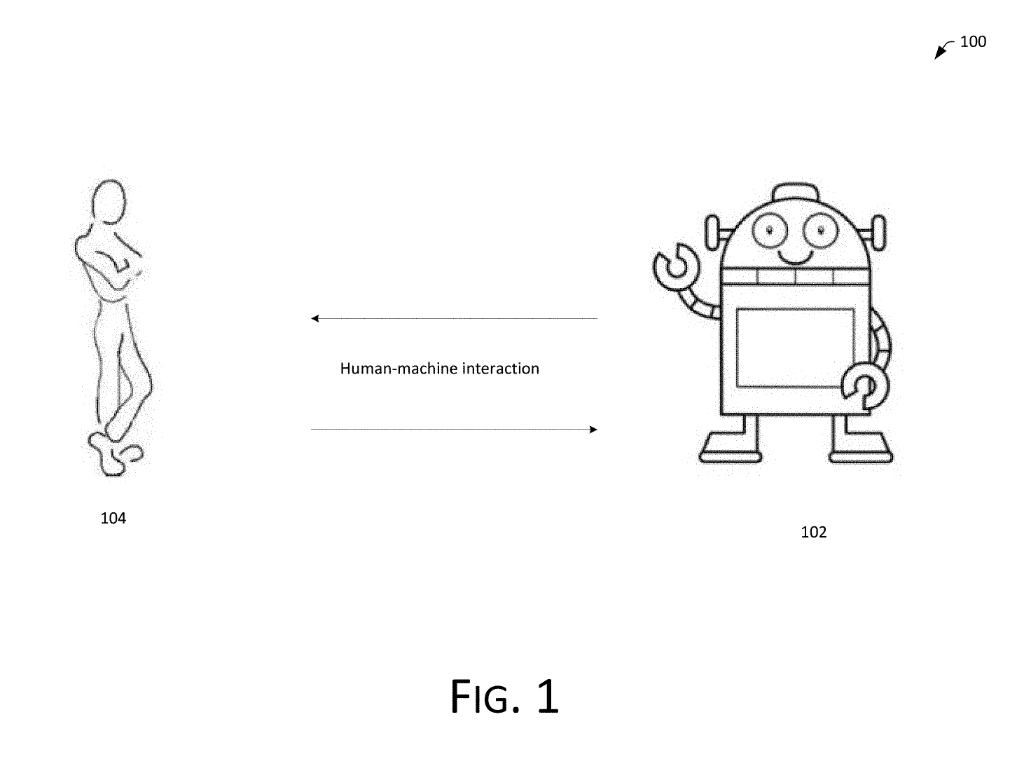

As shown in FIG. 1, a voice interactive system 100 is provided in this example, which includes one or more interactive devices 102, and one or more users 104.

The above voice device may be, for example, a smart speaker, a chat robot having a service providing function, or an application installed in a smart device such as a mobile phone or a computer, etc., which the present disclosure does not have any specific limitation on a type of form thereof.

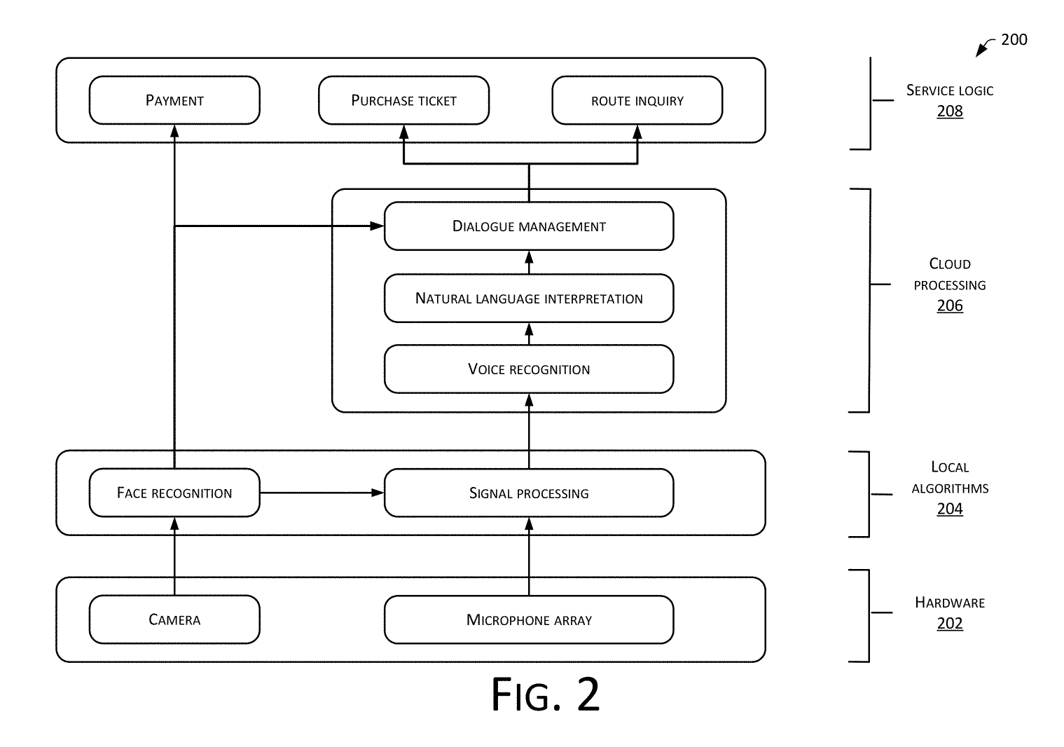

FIG. 2 is a schematic diagram of a service logic implementation 200 for performing voice interaction based on the voice interactive system of FIG. 1, which may include:

1) Hardware 202: a camera and a microphone array may be included.

The camera and the microphone array may be disposed in the voice device 102 as shown in FIG. 1, and portrait information may be obtained by the camera. A position of the mouth may be further determined based on the obtained portrait information, so that a position of a source of sound may be determined. Specifically, the position of the mouth that utters the sound can be determined through the portrait information, thus determining which direction of sound to be the sound that needs to be obtained.

After determining which direction of sound to be the sound that needs to be obtained, directional de-noising can be performed through the microphone array, i.e., the sound in a direction of sound source can be enhanced by the microphone array while noises in directions different from the direction of sound source are suppressed.

In other words, directional de-noising can be performed on the sound through cooperation between the camera and the microphone array.

2) Local algorithms 204: an algorithm based on face recognition and an algorithm based on a signal processing may be included.

The algorithm based on face recognition can be used to determine an identity of a user, and can be used to identify locations of facial features of the user. Identifying whether the user is facing the device, and user payment authentication, etc., can be achieved by the camera with a local face recognition algorithm.

The signal processing algorithm may determine an angle of a sound source after a position of the sound source has been determined, and thereby control a sound pickup of the microphone array to achieve a directional noise cancellation. At the same time, processing such as a certain degree of amplification, filtering and the like can also be performed on the voice that is obtained.

3) Cloud processing 206: cloud implementation or local implementation can be determined according to the processing capabilities of the device and the usage environment, etc. Apparently, if implemented in the cloud, updating and adjusting an algorithmic model can be performed using big data, which can effectively improve the accuracy of voice recognition, natural speech understanding, and dialogue management.

Cloud processing can mainly include voice recognition, natural language understanding, dialogue management, and the like.

Voice recognition mainly recognizes the content of an obtained voice. For example, if a piece of voice data is obtained and a meaning thereof needs to be understood, then specific text content of that piece of voice needs to be known first. Such process needs to convert the voice into a text using voice recognition.

Whether a text or a text itself, a machine needs to determine the meaning represented by the text, and thus needs a natural language interpretation to determine the natural meaning of the text, so that the intent of a user in the voice content and information included therein can be identified.

Because it is a human-computer interaction process, a Q&A session is involved. A dialog management unit can be used. Specifically, a device can actively trigger a question and an answer, and continue to generate question(s) and answer(s) based on a response of a user. These questions and answers require predetermined questions and answers that are needed. For example, in a dialogue for purchasing a subway ticket, content of questions and answers such as a ticket of which subway station you need, how many tickets, etc., need to be configured, while a user correspondingly needs to provide a name of the station and the number of tickets. The dialog management also needs to provide corresponding processing logic for situations in which a user needs to change a name of a station, or to modify a response that has been submitted, etc.

For dialogue management, not only regular conversations are set, but conversation content can also be customized for users according to differences in identities of the users, thus leading to a better user experience.

A purpose of dialogue management is to achieve effective communications with users and to obtain information that is needed to perform operations.

Specific voice recognition, natural speech understanding and dialogue management can be implemented in a cloud or locally, which can be determined according to the processing capabilities of a device itself and a usage environment. Apparently, if implemented in the cloud, updating and adjusting an algorithmic model can be performed using big data, which can effectively improve the accuracy of voice recognition, natural speech understanding and dialogue management. For various payment scenarios and voice interaction scenarios, an iterative analysis and optimization of a voice processing model can be performed, so that the experience of payment and voice interaction can be made much better.

4) Service logic 208: services that the device can provide.

The services may include, for example, payment, ticket purchase, inquiry, display of inquiry results, etc. Through configurations of hardware, local algorithms, and cloud processing, the device can perform the services that are provided.

For example, for a ticketing device, a user requests to buy a ticket through human-computer interactions using the device, and the device can issue the ticket. For a service consulting device, a user can obtain required information through human-computer interactions using the device. These service scenarios often require a payment. Therefore, a payment process generally exists in the service logic. After a user makes a payment, a corresponding service is provided to the user.

Through the service logic and combining with a “visual+voice” intelligent interaction scheme, noises can be reduced, and the accuracy of recognition can be improved. A two-person conversation scenario can be free from interruption, and the purpose of avoiding a wakeup can be achieved. A user can conduct interactions using a natural voice.

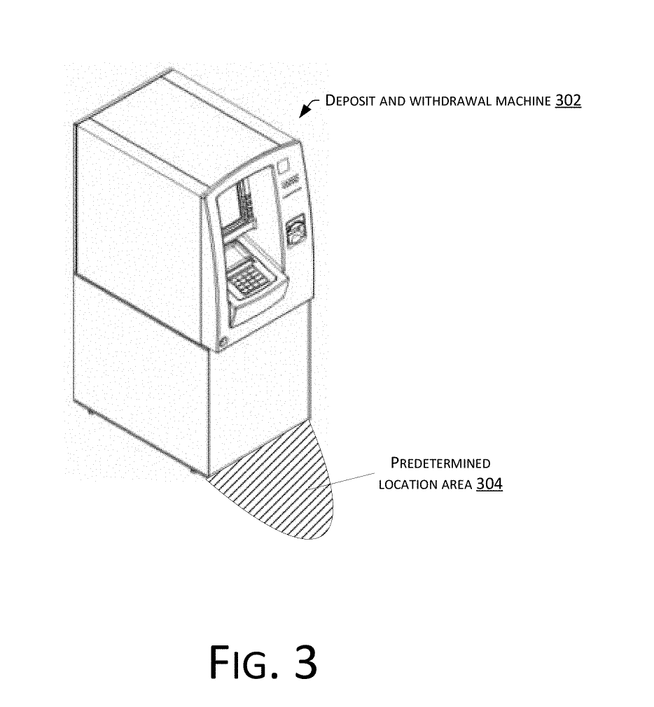

In implementations, the interactive device 102 may pre-set a sensing or triggering area, and initiate a voice interaction in response to detecting that someone is present in the area. FIG. 3 shows a deposit and withdrawal machine 302. The deposit and withdrawal machine 302 is an intelligent interactive device. A sensing area 304 can be set for the device. A shaded area as shown in FIG. 3 is the sensing area 304 corresponding to the deposit and withdrawal machine 302. If someone is found to enter this area 304, the deposit and withdrawal machine 302 can be triggered to proactively perform a voice interaction. In order to achieve triggering and sensing, a human body sensing sensor, an infrared sensor, and a ground pressure sensor may be provided for the deposit and withdrawal machine. By setting sensor(s), whether someone has entered an area at a predetermined position can be detected.

However, it is worth noting that the above-mentioned method of identifying whether a person is present is only an exemplary description. In practical implementations, other methods, such as radar detection, etc., may be used, which are not limited in the present disclosure. Methods that can identify a presence of a person can be applied herein to identify whether a person is present, and specifically, which method is used can be selected according to actual needs, which is not limited in the present disclosure.

However, it is worth noting that the above-mentioned method for identifying whether a person enters a predetermined area is only a schematic description, and other methods may be used for human body recognition in practical implementations.

In implementations, taking into account that a user will face the device and stay in front of the device, or face the device and speak to the device if intending to interact with the device, the interactive device 102 may further determine whether a person is facing the device and a time duration of stay exceeds a predetermined duration, or whether the user is facing the device and is speaking after detecting a presence of the person. In these situations, such user can be considered as having an intention to use the device. In these cases, the device can proactively initiate a voice interaction with the user.

In implementations, in order to identify whether a person is facing the device, an area in which a head is located may be identified from acquired image information using a face recognition technology, and recognition is then performed on the area where the head is located. If facial features such as a nose, eyes, etc., are recognized, the user can be considered to be facing towards the device.

However, it is worth noting that the above-mentioned method of determining whether a person is facing towards the device using the face recognition technology is only an exemplary description, and other methods for determining whether a person is facing towards a device may be used in practical implementations, which are not limited in the present disclosure, and can be selected according to actual requirements and circumstances.

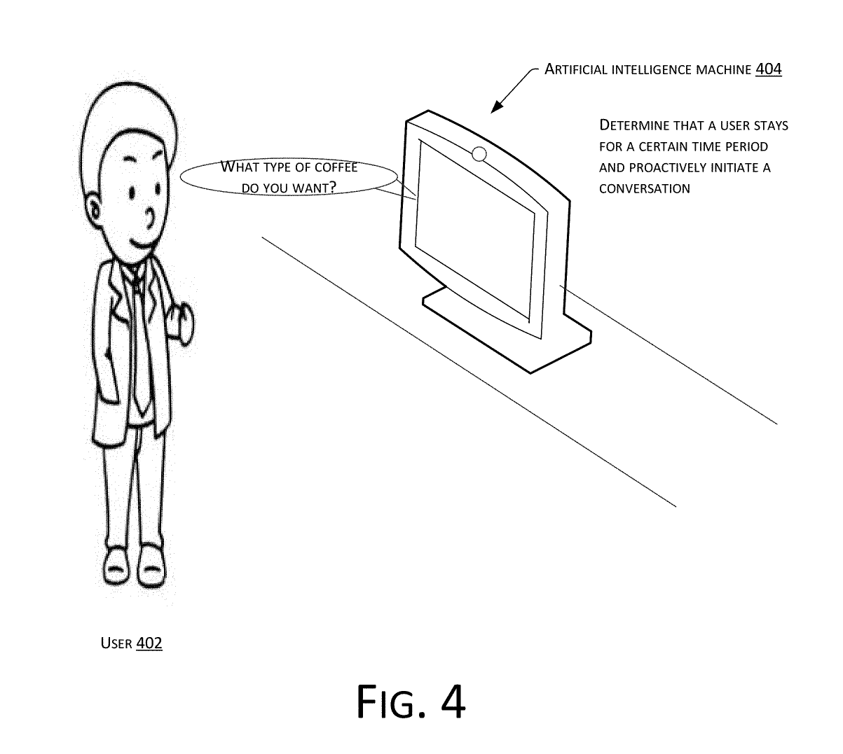

For example, as shown in FIG. 4, a user 402 buys coffee at a coffee shop, and a salesperson at the coffee shop is an artificial intelligence device 404. As such, when the user 402 reaches the coffee shop and stay in front of the device 404 for a time duration reaching a predetermined time duration, the artificial intelligence device 404 can actively initiate a conversation, for example, asking the user 402: “What type of coffee do you want?”, i.e., proactively initiating the conversation by the interactive device.

Considering that different conversations are suitable for different people in many scenarios (for example, if an interactive device is a device for selling clothes, a corresponding question and answer content that needs to be recommended is performed according to an age, a gender, etc., of a person), identity feature information of a user in front of a device, such as an age, a gender, etc., can be determined through computer vision or voiceprint recognition. As such, question and answer data can be generated in a targeted manner.

Specifically, a facial image or the like of user may be obtained, a gender, an age, and the like of the user can be identified. Alternatively, the user's voice can be obtained, and the user's gender, age, and the like can be identified according to a voiceprint of the user. After the user's identity is determined, Q&A data matching the user can be generated. For example, if a woman who is about 30 years old is identified, a question of “Hello, do you want to buy clothes for yourself or buy clothes for your child?” can be asked. If a man of about 50 years old is identified, a question “Hello, clothes in the ** area are more suitable for you, you can take a look, and do you want me to take you over there?” can be asked. In this way, the user experience can be effectively improved, making human-computer interactions more like interactions between people.

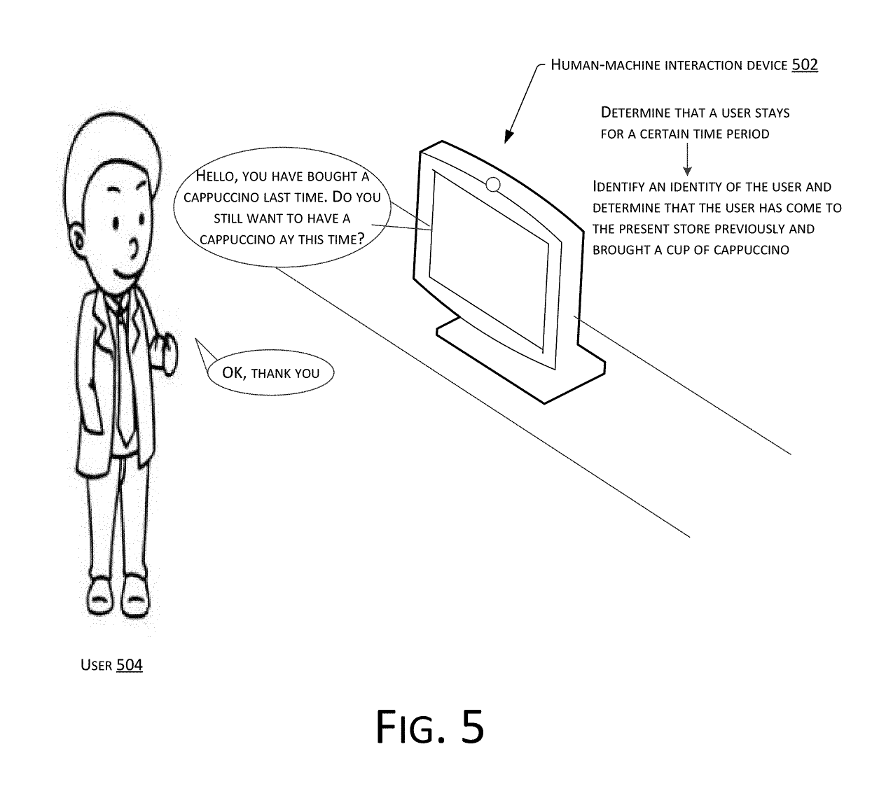

For a human-interaction interaction device, a certain storage function can be set. For example, historical purchasing information or historical behavior data of a customer can be obtained for the customer who has come before, and such user can be provided with suitable questions and answers. For example, as shown in FIG. 5, a coffee shop is used as an example. When a human-interaction interaction device 502 may first acquire feature information of a user 504 upon determining a presence of the user 504, determine whether the user 504 has visited the store before, and obtain information that the user 504 has bought a cappuccino in his/her last visit upon determining that the user 504 has visited the store before. Therefore, question and answer data can be directly generated, and a dialogue is established with the user 504: “Hello, you have bought a cappuccino last time. Do you still want to have a cappuccino ay this time?” In this way, the user experience can be effectively improved.

In implementations, in order to enable an interactive device to communicate with a user effectively, in implementations, the interactive device may perform de-noising processing on the user's voice that is obtained, and perform semantic recognition on voice data after the de-noising processing. Specifically, voice response data of the user may be converted into a text.

Considering that an operation may not be triggered through one set of question and answer for some use scenarios in practice, a series of questions may be configured, and an operation can be performed after all the questions have respective answers. For example, user A goes to a tea shop to buy milk tea, and an interactive device of the tea shop asks “Hello, which milk tea do you want to choose?”, and user A replies: “I want a cup of Oolong Macchiato”. The device continues to ask “How sweet?”, and user A replies “Half sweet”. The device asks, “Hot or cold?”, and user A answers “Cold without ice”. The device asks, “A large cup or medium cup?”, and user A answers “A large cup, thank you!” Finally, the device confirms by sending a confirmation voice to User A, “You want a large cup of half sweet Oolong Macchiato.” After confirmation, the interactive device can generate an order of “a large cup of half sweet Oolong Macchiato”.

In implementations, in order to achieve the purpose of the above way of questions and answers, a plurality of question and answer items may be set in advance. Only after each question and answer item is confirmed, a final operation (for example, generating an order) is performed. For example, a list form may be used, and a plurality of items may be listed in a list. Each time when there is a corresponding response content, the response content is filled in a corresponding position. In response to determining that each position is filled, a determination can be made that all questions and answers have been confirmed and a corresponding action can be triggered.

Taking into account that a response of a user is sometimes not very accurate, response content of the user can be identified using a natural semantic recognition technology. When a response of a user does not meet a predetermined requirement, a scope of a response that answers to a question can be narrowed down, or candidate items can be provided to help the user to respond. After enough information is obtained, a corresponding operation can be triggered.

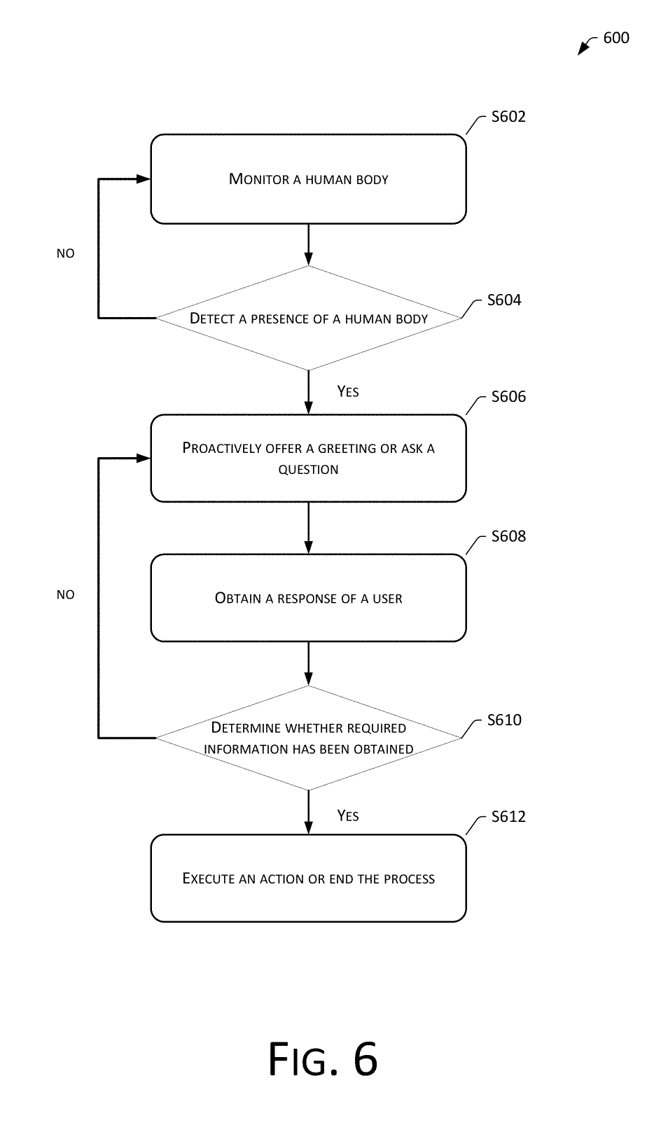

Description is made in conjunction with a particular scenario. For example, an entire process 600 can be as shown in FIG. 6, which includes the following operations.

S602: Monitor a human body in front of a device through face recognition in real time, and simultaneously determine characteristics of a user such as an identity (for example, a specific customer group or a specific user), an age (for example, an elderly person or a child), a gender, and the like.

S604: Detect whether a person appears in front of the device and the person faces the device and stays in front of the device for a period of time.

S606: In response to detecting that a person appears in front of the device and the person faces the device and stays in front of the device for a period of time, the device can proactively trigger to offer a greeting or ask a question through voice.

S608: Convert voice data of the person into a text using a voice recognition technology.

S610: Identify content that the person responds through a semantic analysis. When a response of the person is inappropriate, a response range of the response can be narrowed down and the question is re-asked, or other selectable options can be provided to the user for selection to help the person to respond.

S612: Perform an operation after determining that sufficient information is obtained.

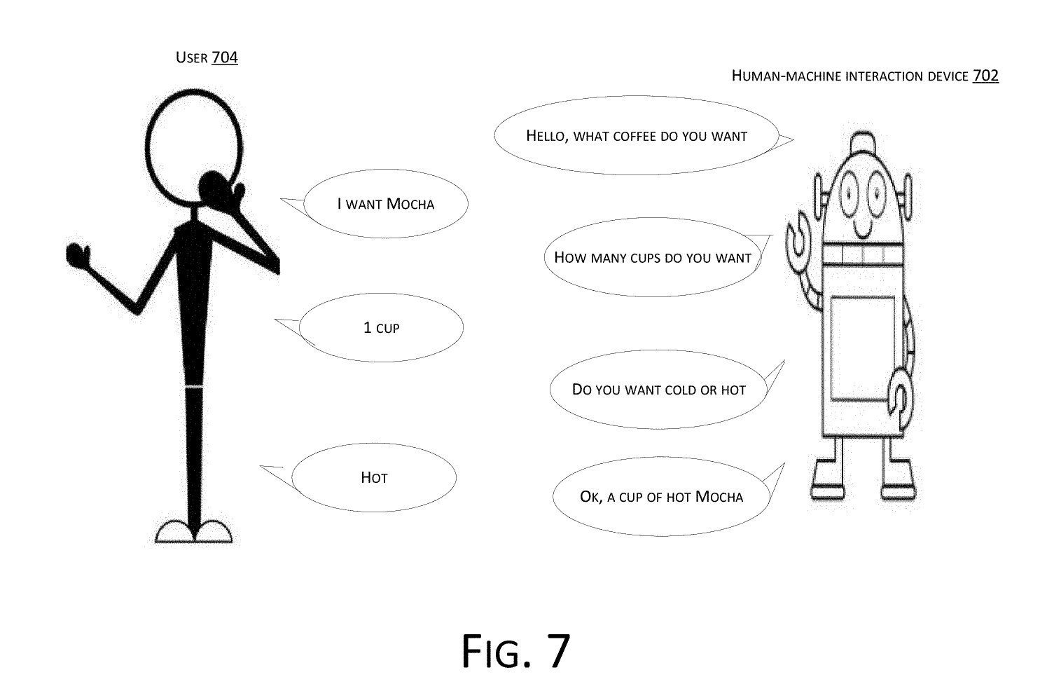

For example, as shown in FIG. 7, an interactive device or human-machine interaction device 702 at a coffee shop can actively interact with a customer or user 704 as follows:
Device: Hello, what coffee do you want?
User: I want Mocha.
Device: How many cups do you want?
User: 1 cup.
Device: Do you want cold or hot?
User: Hot.
Device: Ok, a cup of hot mocha.

An inquiry device in an airport is used as an example for description. The device can perform real-time monitoring to determine whether a passenger appears in a predetermined area, and determine whether the passenger is facing the device when staying within the predetermined area, and whether staying for a period of time exceeding a predetermined period of time or whether facing and speaking to the device. In response to detecting that the passenger is facing the device and stays for the predetermined period of time, or speaks to the device, the passenger may be considered to have an intention to use the device. At this time, the device can initiate an inquiry operation actively. For example, the device actively generates voice communication data, and asks the user: Hello, do you need any help? Information of an answer given by the user can then be obtained to determine whether it is necessary to continue to provide services to the passenger.

For example, a subway ticketing device can initiate an inquiry: Hello, do you want to buy a ticket? If you want to buy a ticket, you can tell the destination station and the number of tickets you want to buy. Specifically, the device actively triggers a ticket purchasing process and informs a user of information that needs to be provided. Apparently, the user can say “I want to buy a ticket to Suzhou Street subway station” to the ticketing device. At this time, the device extracts information therein and determines that the user has provided the “destination”. A condition is further required, which is the “number of tickets”. Therefore, an operation of ticket purchase cannot be triggered, and the user is required to provide information about the “number of sheets”. In this case, a question can be asked to the user “How many tickets to the Suzhou Street subway station do you need”. After obtaining the information about the number of tickets replied by the user, a determination can be made that trigger conditions have been met, i.e., both the number of tickets and the destination are known. In this case, the ticketing process can be triggered to remind the user to pay the fare, and in the case of determining that a payment has been made, two subway tickets to the Suzhou Street subway station are printed.

Specifically, the device actively triggers the ticket purchasing process. In order to obtain complete trigger conditions, question-and-answer pairs can be set. For example, knowing that a purchase of subway ticket(s) needs to know a “destination station” and a “number of tickets”, question-and-answer pairs can be set in advance, i.e., a question-and-answer pair of corresponding to the destination station, a question-and-answer pair corresponding to the number of tickets. In a situation when these question-and-answer pairs are known, i.e., a situation in which number of tickets and the destination are known, a ticketing process can be triggered. If information provided by a user is incomplete, a corresponding question in the question-and-answer pairs is asked. For example, if a user gives a destination station, but does not say about the number of tickets, the user can be inquired by a predetermined question corresponding to the number of tickets to obtain information about the number of tickets.

The above example is an example of purchasing a subway ticket. For other scenarios, it is generally necessary to set question-and-answer pairs with respect to respective requirements of the scenarios. For example, if it is a machine that purchases a train ticket, not only a “destination” and a “number of ticket” need to be known, but a “place of departure”, a “departure time”, and a “seat type” are also needed to be known, in order to obtain complete condition information to trigger a ticketing process. Therefore, it is necessary to set not only question-and-answer pairs corresponding to the “destination” and the “number of tickets”, but also question-and answer-pairs corresponding to the “place of departure”, the “departure time” and the “seat type”.

Dialogues in different inquiry scenarios when a subway ticket is purchased are used as examples.

Dialogue 1 (a fast ticket purchasing process):

A user walks to the front of a ticket vending machine of Shanghai Railway Station. A camera of the ticket vending machine captures that a person is facing towards the device, and a time duration of stay exceeds a predetermined duration. A determination can be made that the user is intended to use the device to purchase a ticket. At this time, the ticket vending machine can actively trigger a process of purchasing a ticket, and inquiry the user, thus eliminating the need to be woken up by the user and avoiding a learning process on the device by the user. For example,

Ticket vending machine: Hello, please tell me your destination and number of tickets. (this greeting and question-and-answer approach can be pre-configured by dialogue management).

User: I want a ticket to People's Square.

After obtaining “I want a ticket to People's Square” submitted by the user, the ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that information about the “destination” and the “number of tickets” has been carried therein, and therefore can determine that information required for making a ticket purchase has been satisfied. Accordingly, the next conversation content can be determined to be telling the user an amount that needs to be paid.

The ticket vending machine can display or voice broadcast: (ticket details) a total of 5 dollars, please scan the code to pay.

The user pays the fare through a response APP scan code such as Alipay, etc. After confirming that the fare has been paid, the ticket vending machine can execute a ticket issuing process and issue a subway ticket to People's Square.

Dialogue 2 (a ticket purchasing process that requires an injury about the number of tickets):

A user walks to the front of a ticket vending machine of Shanghai Railway Station. A camera of the ticket vending machine captures that a person is facing the device, and a time duration of stay exceeds a predetermined duration. A determination can be made that the user is intended to use the device to purchase a ticket. At this time, the ticket vending machine can actively trigger a ticket purchasing process, and ask the user, thus eliminating the need to be woken up by the user and avoiding a learning process on the device by the user. For example,

Ticket vending machine: Hello, please tell me your destination and number of tickets.

User: I want to go to People's Square.

After obtaining “I want to go to People's Square” submitted by the user, the ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that only information about the “destination” is carried, and information about the “number of tickets” is still missing. Therefore, the dialog management can be invoked to generate the next question, asking the user for the number of tickets needed.

Ticket vending machine: The fare to People's Square is 5 dollars, how many tickets do you want to buy?

User: 2 tickets.

After obtaining “2 tickets” submitted by the user, the ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that two pieces of information, namely, the “destination” and the “number of tickets”, have appeared, and therefore can determine that information required for making a ticket purchase has been satisfied. Accordingly, the next conversation content can be determined to be telling the user an amount that needs to be paid.

Ticket vending machine: (show ticket details) a total of 10 dollars, please scan the code to pay.

The user pays the fare through a response APP scan code such as Alipay, etc. After confirming that the fare has been paid, the ticket vending machine can execute a ticket issuing process and issue 2 subway tickets to People's Square.

Dialogue 3 (a ticket purchasing process with interrupted dialogue):

A user walks to the front of a ticket vending machine of Shanghai Railway Station. A camera of the ticket vending machine captures that a person is facing the device, and a time duration of stay exceeds a predetermined duration. A determination can be made that the user is intended to use the device to purchase a ticket. At this time, the ticket vending machine can actively trigger a ticket purchasing process, and ask the user, thus eliminating the need to be woken up by the user and avoiding a learning process on the device by the user. For example,

Ticket vending machine: Hello, please tell me your destination and number of tickets.

User: I want to go to People's Square.

After obtaining “I want to go to People's Square” submitted by the user, the ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that only information about the “destination” is carried in the voice information, and information about the “number of tickets” is still missing. Therefore, the dialog management can be invoked to generate the next question, asking the user for the number of tickets needed.

Ticket vending machine: The fare to People's Square is 5 dollars, how many tickets do you want to buy?

User: No, I would like to go to Shaanxi South Road instead.

After obtaining “No, I would like to go to Shaanxi South Road instead” submitted by the user, the ticket vending machine can recognize voice data. First, voice recognition is performed, and content carried in the voice is recognized. Semantic recognition is then performed to recognize that the intent of the voice and information carried herein is not about the number of tickets, but a modification of the destination. Therefore, it is determined that the user wants to go not to Shaanxi South Road instead of People's Square. As such, the destination can be modified to “Shaanxi South Road”. Further, the recognized content can be sent to the dialog management. The dialog management determines that only destination information is present, and information about the “number of tickets” is still missing. Therefore, the dialog management can be invoked to generate the next question to the user, asking the number of tickets required.

Ticket vending machine: Ok, the fare to Shaanxi South Road is 6 dollars. How many tickets do you want to buy?

User: 2 tickets.

After obtaining “2 tickets” submitted by the user, the ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that two pieces of information, namely, the “destination” and the “number of tickets”, have appeared, and therefore can determine that information required for making a ticket purchase has been satisfied. Accordingly, the next conversation content can be determined to be telling the user an amount that needs to be paid.

Ticket vending machine: (show ticket details) a total of 10 dollars, please scan the code to pay.

The user pays the fare through a response APP scan code such as Alipay, etc. After confirming that the fare has been paid, the ticket vending machine can execute a ticket issuing process and issue 2 subway tickets to Shaanxi South Road.

Dialogue 4 (recommendations for lines and subway lines):

A user walks to the front of a ticket vending machine of Shanghai Railway Station. A camera of the ticket vending machine captures that a person is facing the device, and a time duration of stay exceeds a predetermined duration. A determination can be made that the user is intended to use the device to purchase a ticket. At this time, the ticket vending machine can actively trigger a ticket purchasing process, and ask the user, thus eliminating the need to be woken up by the user and avoiding a learning process on the device by the user. For example,

Ticket vending machine: Hello, please tell me your destination and number of tickets.

User: I want to go to Metro Hengtong Building.

After obtaining the “I want to go to Metro Hengtong Building” submitted by the user, the ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that the “destination” information has been carried therein. Conversation content of a route notification is configured in the dialog management module. After the destination is obtained, route information corresponding to the destination can be matched and given to the user. Therefore, subway buffer information that is determined can be provided to the user in a form of a dialogue or an information display, for example:

Ticket vending machine: (showing a target map) You are recommended to take Line Number 1, get off at Hanzhong Road Station, and take exit 2.

User: Ok, buy one ticket.

The ticket vending machine can recognize voice data. First, voice recognition is performed, and the content carried by the voice is recognized. Semantic recognition is then performed to recognize the intent of this piece of voice and information carried therein. Further, the recognized content can be sent to the dialog management, and the dialog management determines that two pieces of information, namely, the “destination” and the “number of tickets”, have appeared, and therefore can determine that information required for making a ticket purchase has been satisfied. Accordingly, the next conversation content can be determined to be telling the user an amount that needs to be paid.

Ticket vending machine: (show ticket details) a total of 5 dollars, please scan the code to pay.

The user pays the fare through a response APP scan code such as Alipay, etc. After confirming that the fare has been paid, the ticket vending machine can execute a ticket issuing process and issue one ticket to Hengtong Building.

It is worth noting that the above description is only an exemplary description of dialogues in scenarios. Other dialogue modes and processes may be adopted in practical implementations, which are not limited in the present disclosure.

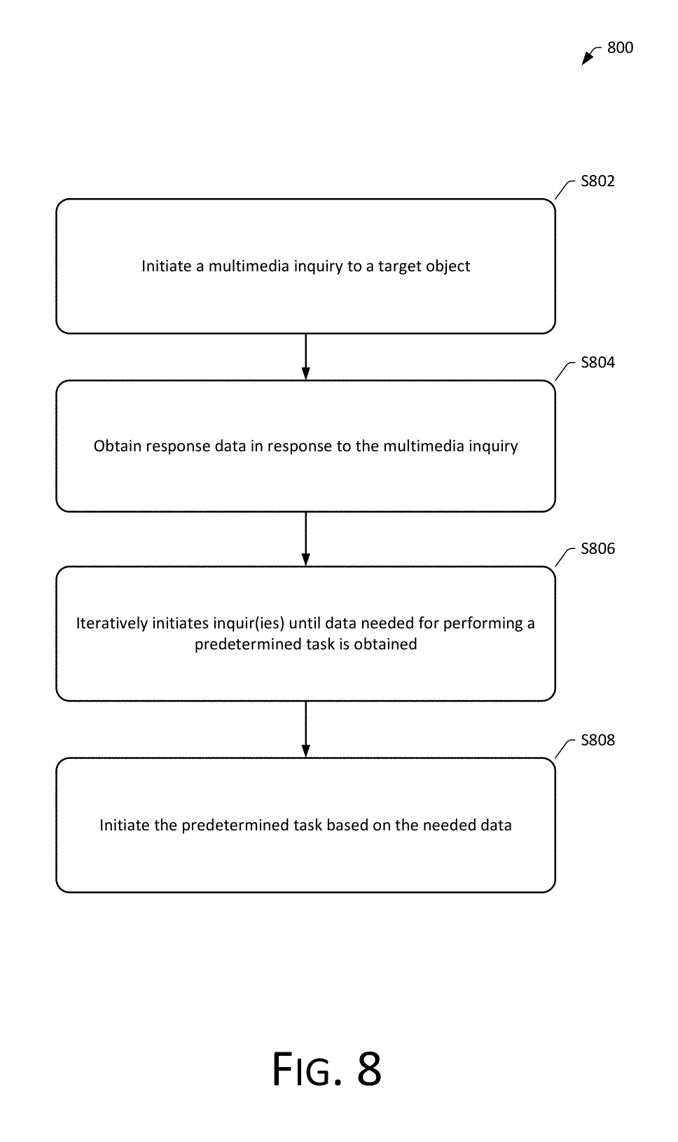

FIG. 8 is a method flowchart of a task processing method 800 according to the embodiments of the present disclosure. Although the present disclosure provides operational steps of methods or structures of apparatuses as shown in the following embodiments or figures, more or fewer operational steps or modular units may be included in the methods or apparatuses based on conventional or non-inventive effort. In steps or structures without an existence of any necessary causal relationship therebetween in a logical sense, orders of execution of the steps or modular structures of the apparatuses are not limited to the orders of execution or the modular structures shown in the description of the embodiments and the drawings of the present disclosure. When the methods or modular structures are applied in a device or terminal product in practice, execution may be sequentially performed according to the methods or the modular structures shown in the embodiments or the figures or in parallel (for example, a parallel processor or multi-thread processing environment, even a distributed processing environment).

Specifically, as shown in FIG. 8, the task processing method 800 provided by the embodiments of the present disclosure may include the following operations.

S802: Initiate a multimedia inquiry to a target object.

Specifically, for a device, an inquiry can be initiated proactively. For example, if a device detects that a person exists in a predetermined location area and determines that the person in the predetermined location area is facing towards the device and stays for a period of time exceeding a predetermined duration using computer visual recognition, the device can actively initiate a voice interaction with the detected person. This type of proactive initiation can avoid false positives. For example, some people merely pass by in front of the device, and have no need. Therefore, restrictive operations such as time duration of stay and whether facing a device, etc., are added to avoid causing an excessive interruption to users.

In implementations, it is possible to detect whether there is a person in the predetermined position area by one of the following methods: a human body sensing sensor, an infrared recognition device, and a ground pressure sensor.

S804: Obtain response data in response to the multimedia inquiry.

In order to make question and answer content more suitable to identities of users to provide more personalized services to the users, identity information of the detected person may be determined, and a voice question and answer corresponding to the identity information is then initiated. The identity information may include, but is not limited to, at least one of the following: an age, a gender.

Considering that a number of current methods of identifying an identity of a person exist, identity information of the detected person may be determined by obtaining image data and/or sound data of the detected person, i.e., identifying an identity of a user using face recognition or identity recognition.

For a human-machine interaction device, a certain storage function can be set. For example, historical purchasing information or historical behavior data of a customer can be obtained for the customer who has come before, and such user can be provided with suitable questions and answers. For example, as shown in FIG. 4, a coffee shop is used as an example. When a human-machine interaction device may first acquire feature information of a user upon determining a presence of the user, determine whether the user has visited the store before, and obtain information that the user has bought a cappuccino in his/her last visit upon determining that the user has visited the store before. Therefore, question and answer data can be directly generated, and a dialogue is established with the user: “Hello, you have bought a cappuccino last time. Do you still want to have a cappuccino ay this time?” In this way, the user experience can be effectively improved.

S806: Iteratively initiates one or more inquiries until data needed for performing a predetermined task is obtained.

S808: Initiate the predetermined task based on the needed data.

Specifically, after the voice interaction is initiated, a voice question and answer may be actively initiated to the detected person. A reply content that is responsive to the voice question and answer is obtained. Whether the reply content meets a triggering condition for the device to perform a predetermined operation is determined. In an event that the triggering condition is not satisfied, voice question(s) and answer(s) is/are continuously initiated to the detected person. In response to determining that the triggering condition is satisfied, the predetermined operation is performed. In other words, if determining that reply data does not satisfy the triggering condition, condition item(s) that is/are missing may be determined, and a voice question and answer is initiated to the target object based on the determined condition item(s) that is/are missing, until reply data satisfies the triggering condition, and the predetermined operation is then performed.

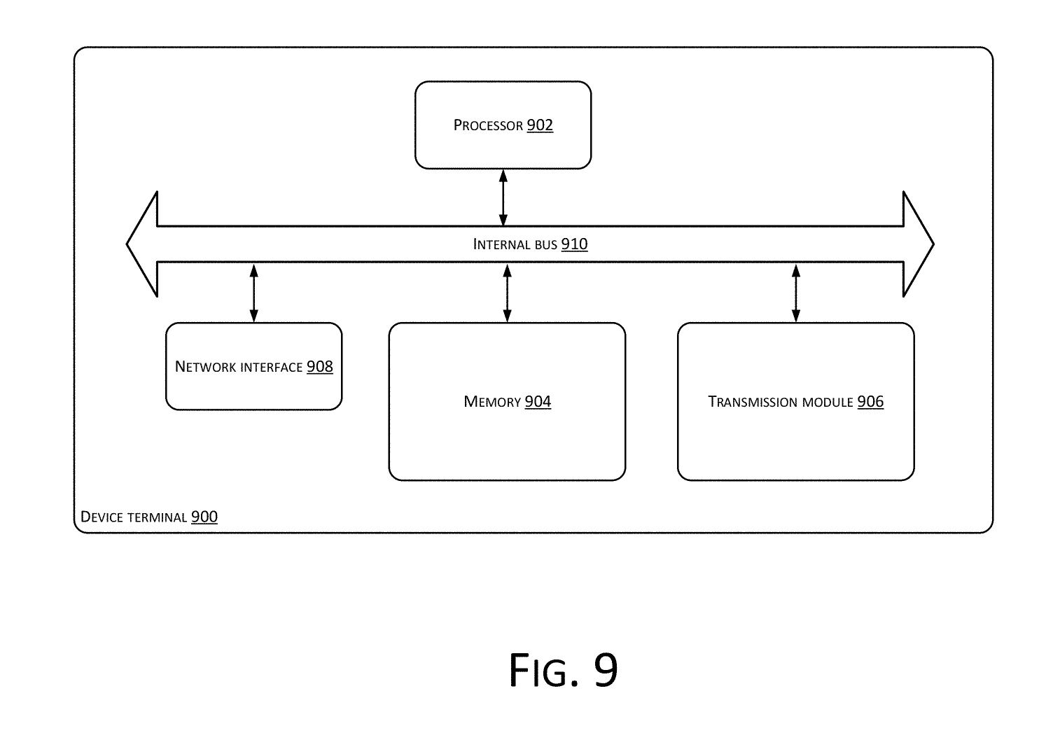

The method embodiments provided by the present disclosure can be implemented in a mobile terminal, a computer terminal, a computing apparatus, or the like. A computer terminal is used as an example. FIG. 9 is a structural block diagram of hardware of a device terminal 900 for an interactive method according to the embodiments of the present invention. As shown in FIG. 9, a device terminal 900 may include one or more (only one of which is shown in the figure) processors 902 (the processor 902 may include, but is not limited to, a processing device such as a microprocessor (MCU) or a programmable logic device (FPGA)), memory 904 used for storing data, and a transmission module 906 used for communication functions. In implementations, the device terminal 900 may further include a network interface 908 used for connecting the device terminal 900 to one or more networks such as the Internet, and an internal bus 910 connecting different components (such as the processor 902, the memory 904, the transmission module 906, and the network interface 908) with one another. One skilled in the art can understand that the structure shown in FIG. 9 is merely illustrative and does not have any limitations on a structure of the above electronic device. For example, the device terminal 900 may also include more or fewer components than the ones shown in FIG. 9, or have a different configuration than the one shown in FIG. 9.

The memory 904 can be configured to store software programs and modules of application software, such as program instructions/modules corresponding to the data interactive method(s) in the embodiment(s) of the present invention. The processor 902 executes various functions, applications and data processing by running software program(s) and module(s) stored in the memory 904, i.e., implementing the data interactive method(s) of the above application program(s). The memory 904 may include high speed random access memory and may also include non-volatile memory such as one or more magnetic storage devices, flash memory, or other non-volatile solid-state memory. In some examples, the memory 904 may further include storage devices that are remotely located relative to the processor 902. These storage devices may be coupled to the computer terminal 900 via a network. Examples of the network include, but are not limited to, the Internet, an intranet, a local area network, a mobile communication network, and a combination thereof.

The transmission module 906 is configured to receive or transmit data via a network. Specific examples of the network may include a wireless network provided by a communication provider of the computer terminal 900. In an example, the transmission module 906 includes a Network Interface Controller (NIC) that can be connected to other network devices through a base station and thereby communicate with the Internet. In an example, the transmission module 906 can be a Radio Frequency (RF) module, which is used for conducting communications with the Internet wirelessly.

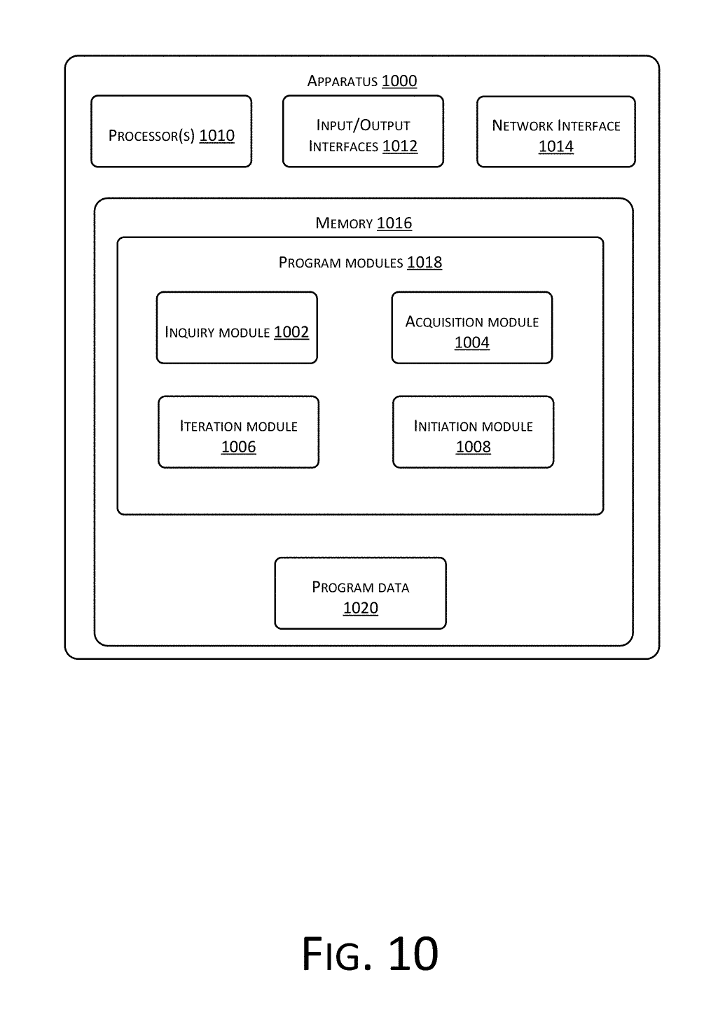

FIG. 10 is a structural block diagram of a human-machine interaction apparatus 1000. In implementations, the apparatus 1000 may include one or more computing devices. In implementations, the apparatus 1000 may be a part of one or more computing devices, e.g., implemented or run by the one or more computing devices. In implementations, the one or more computing devices may be located in a single place or distributed among a plurality of network devices over a network. By way of example and not limitation, the apparatus 1000 may include an inquiry module 1002, an acquisition module 1004, an iteration module 1006, and an initiation module 1008.

The inquiry module 1002 is configured to initiate a multimedia inquiry to a target object.

The acquisition module 1004 is configured to obtain response data in response to the multimedia inquiry.

The iteration module 1006 is configured to iteratively initiate one or more inquiries until data needed for performing a predetermined task is obtained.

The initiation module 1008 is configured to initiate the predetermined task based on the needed data.

In implementations, iteratively initiating the one or more inquiries until the data needed for performing the predetermined task is obtained may include obtaining the response data; determining whether the response data includes all data needed for performing the predetermined task; determining missing data item(s) in response to determining that not all the data that is needed is included; initiating a multimedia inquiry to the target object based on the determined missing data item(s) until the data needed for performing the predetermined task is obtained.

In implementations, initiating the multimedia inquiry to the target object includes determining identity information of the target object; and initiating the multimedia inquiry corresponding to the identity information.

In implementations, determining the identity information of the target object may include determining the identity information of the target object by obtaining image data and/or sound data of the target object.

In implementations, initiating the multimedia inquiry to the target object may include detecting whether the target object is present in a predetermined location area of the device; determining whether the target object is facing the device and stays for a time period that exceeds a predetermined time duration in response to determining that the target object is present; and initiating the multimedia inquiry to the target object in response to determining that the target object is facing the device and stays for the time period that exceeds the predetermined time duration.

In implementations, detecting whether the target object exists in the predetermined location area of the device may include detecting whether the target object exists in the predetermined location area of the device, by, but not limited to, at least one of the following ways: a human body sensor, an infrared sensor, and a ground pressure sensor.

In implementations, initiating the multimedia inquiry to the target object may include determining whether a question-and-answer pair is stored; and initiating the multimedia inquiry to the target object based on the question-and-answer pair in response to determining that the question-and-answer pair is stored.

In implementations, the question and answer pair may include necessary information corresponding to an execution of the predetermined task.

In implementations, initiating the multimedia inquiry to the target object may include obtaining historical behavior data of the target object; and generating the multimedia inquiry corresponding to the target object according to the historical behavior data.

In implementations, the multimedia inquiry may include, but is not limited to, at least one of the following: a text inquiry, a voice inquiry, an image inquiry, and a video inquiry.

In implementations, the apparatus 1000 may further include one or more processors 1010, an input/output (I/O) interface 1012, a network interface 1014, and memory 1016.

The memory 1016 may include a form of computer readable media such as a volatile memory, a random access memory (RAM) and/or a non-volatile memory, for example, a read-only memory (ROM) or a flash RAM. The memory 1016 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1016 may include program modules 1018 and program data 1020. The program modules 1018 may include one or more of the modules as described in the foregoing description and shown in FIG. 10.

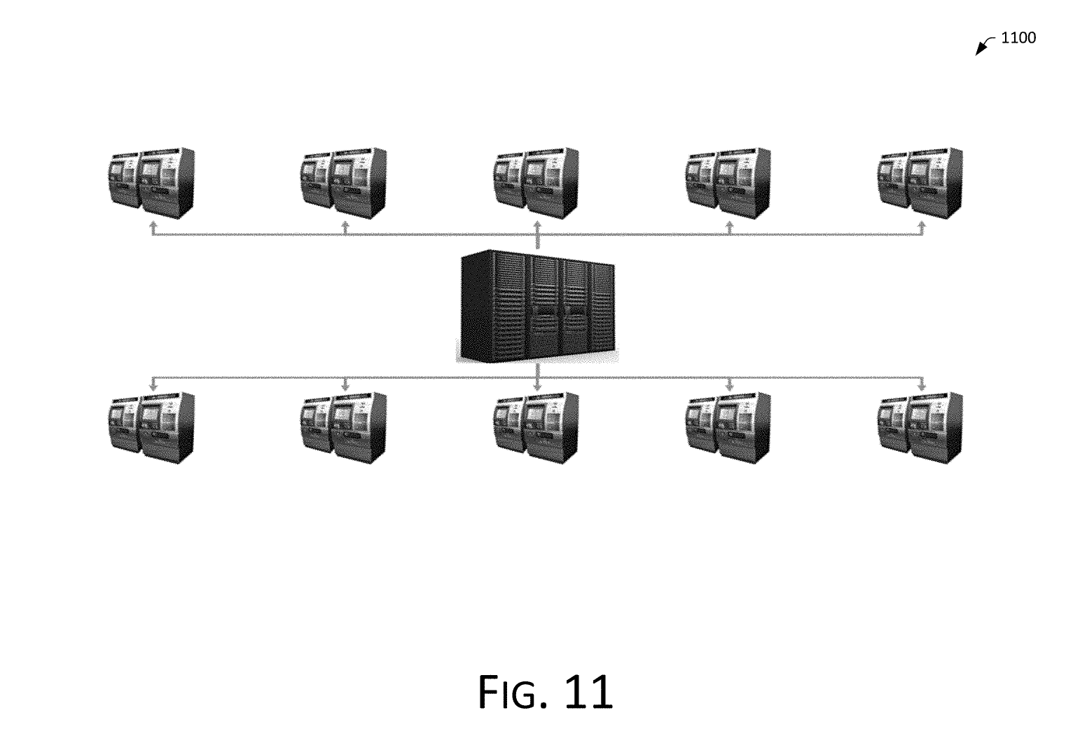

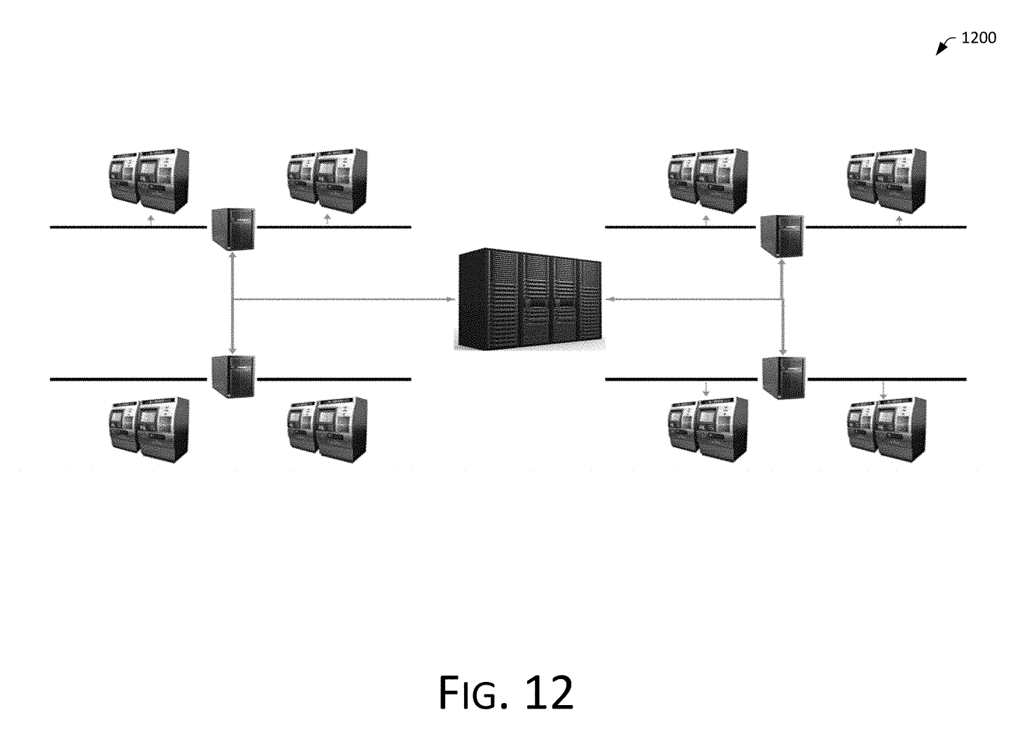

For some large-scale voice interaction scenarios or payment scenarios, two deployment modes are provided in this example. FIG. 11 shows a centralized deployment mode 1100, i.e., multiple human-machine interaction devices are respectively connected to a same processing center. The processing center may be a cloud server, a server cluster, or the like, and the processing center may perform processing on data, or centralized control of the human-machine interactive devices. FIG. 12 shows a large centralized and small dual active deployment mode 1200, in which every two human-machine interactive devices are connected to a small processing center, and the small processing center controls these two human-machine interactive devices connected thereto. All small processing centers are connected to a same large processing center, and a centralized control is performed through the large processing center.

However, it is worth noting that the deployment methods listed above are only an exemplary description. In practical implementations, other deployment methods may also be adopted. For example, a large centralized and triple active deployment mode, etc., and the number of human-computer interactive devices connected to each small processing center being not equal, and the like, can be used as alternative deployment modes, and can be selected according to actual needs, which are not limited in the present disclosure.

The human-computer interactive systems and methods, and the voice de-noising methods, etc., that are provided in the present disclosure can be applied to service situations such as court trials, customer service's quality inspections, live video broadcasts, journalist's interviews, meeting minutes, doctor's consultations, etc., and can be applied in customer service machines, smart financial investment consultants, various types of APP, or all kinds of intelligent hardware devices, such as mobile phones, speakers, set-top boxes, vehicle-mounted devices, etc. What needs to be involved are audio recording file recognition, real-time voice recognition, text big data analysis, short voice recognition, speech synthesis, intelligent dialogue, and so on.

In the task processing method and device provided by the present disclosure, the device proactively initiates an inquiry and iteratively initiates the inquiry until data needed for performing a predetermined task is obtained, thereby providing a proactive task processing method. The method can solve existing technical problems of a poor user experience due to the need of a user to actively wake up or actively initiate an interaction, and thus effectively achieve an enhancement in the user experience.

The apparatuses or modules illustrated in the above embodiments may be implemented by a computer chip or an entity, or by a product having certain functions. For the convenience of description, the above apparatuses are divided into various modules in terms of functions for separate descriptions. Functions of the various modules may be implemented in one or more software and/or hardware components when the present disclosure is implemented. Apparently, a module that implements a certain function may also be implemented by a combination of a plurality of sub-modules or subunits.

The methods, apparatuses, or modules described in the present disclosure can be implemented in a form of computer readable program codes. A controller can be implemented in any suitable manner. For example, a controller can take a form of, for example, microprocessors or processors and computer readable media storing computer readable program codes (e.g., software or firmware) executed by the (micro)processors, logic gates, switches, application specific integrated circuits (ASICs), programmable logic controllers, and embedded microcontrollers. Examples of controllers include, but are not limited to, the following microcontrollers: ARC 625D, Atmel AT91SAM, Microchip PIC18F26K20, and Silicone Labs C8051F320. A memory controller can also be implemented as a part of control logic of the memory. It will also be apparent to one skilled in the art that logical programming can be performed completely using operations of the method(s) to cause the controller to implement the same functions in a form of logic gates, switches, application specific integrated circuits, programmable logic controllers, and embedded microprocessors, etc., in addition to implementing the controller in a form of purely computer readable program codes. Therefore, such type of controller can be considered as a hardware component, and an internal apparatus used for implementing various functions can also be regarded as a structure within a hardware component. Alternatively, even an apparatus used for implementing various functions can be considered as a software module and a structure within a hardware component that can implement the method(s).

Some modules in the apparatuses described in the present disclosure may be described in the general context of computer-executable instructions executed by a computer, such as program modules. Generally, program modules include routines, programs, objects, components, data structures, classes, etc., that perform designated tasks or implement designated abstract data types. The present disclosure can also be practiced in a distributed computing environment in which tasks are performed by remote processing devices that are connected through a communication network. In a distributed computing environment, program modules can be located in both local and remote computer storage media including storage devices.

It will be apparent to one skilled in the art from the above description of the embodiments that the present disclosure can be implemented by means of software plus necessary hardware. Based on such understanding, the essence of technical solutions of the present disclosure or the parts that make contributions to the existing technologies may be manifested in a form of a software product, or may be manifested in an implementation process of data migration. The computer software product may be stored in a storage media, such as ROM/RAM, a magnetic disk, an optical disk, etc., and includes a plurality of instructions for causing a computing device (which may be a personal computer, a mobile terminal, a server, or a network device, etc.) to execute the method described in each embodiments or a part of the embodiment.

The various embodiments in the specification are described in a progressive manner, and the same or similar parts between the various embodiments may be referenced to each other. Each embodiment put an emphasis on an area that is different from those of other embodiments. All or part of the present disclosure can be used in a number of general purpose or special purpose computer system environments or configurations, such as a personal computer, a server computer, a handheld device or portable device, a tablet device, a mobile communication terminal, a multiprocessor system, a microprocessor-based system, a programmable electronic device, a network PC, a small-scale computer, a mainframe computer, a distributed computing environment that includes any of the above systems or devices, etc.

Although the present disclosure has been described using the embodiments, one of ordinary skill in the art understands that a number of variations and modifications exist in the present disclosure without departing the spirit of the present disclosure. The appended claims are intended to include these variations and modifications without departing the spirit of the present disclosure.

The present disclosure can be further understood using the following clauses.

Clause 1: A task processing method comprising: initiating a multimedia inquiry to a target object; obtaining response data in response to the multimedia inquiry; iteratively initiating one or more inquiries to obtain data for performing a predetermined task; and initiating the predetermined task based on the obtained data.

Clause 2: The method of Clause 1, wherein iteratively initiating the one or more inquiries to obtain the data for performing the predetermined task comprises: obtaining the response data; determining whether the response data includes all the data for performing the predetermined task; determining missing data item(s) in response to determining that not all the data is included; initiating a multimedia inquiry to the target object based on the determined missing data item(s) to obtain the data for performing the predetermined task.

Clause 3: The method of Clause 1, wherein initiating the multimedia inquiry to the target object comprises: determining identity information of the target object; and initiating the multimedia inquiry corresponding to the identity information.

Clause 4: The method of Clause 3, wherein the identity information comprises at least one of: an age or a gender.

Clause 5: The method of Clause 3, wherein determining the identity information of the target object comprises determining the identity information of the target object by obtaining image data and/or sound data of the target object.

Clause 6: The method of Clause 1, wherein initiating the multimedia inquiry to the target object comprises: detecting whether the target object is present in a predetermined location area of the device; determining whether the target object is facing the device and stays for a time period that exceeds a predetermined time duration in response to determining that the target object is present; and initiating the multimedia query to the target object in response to determining that the target object is facing the device and stays for the time period that exceeds the predetermined time duration.

Clause 7: The method of Clause 6, wherein detecting whether the target object exists in the predetermined location area of the device comprises detecting whether the target object exists in the predetermined location area of the device by at least one of: a human body sensor, an infrared sensor, or a ground pressure sensor.

Clause 8: The method of Clause 1, wherein initiating the multimedia inquiry to the target object comprises: determining whether a question-and-answer pair is stored; and initiating the multimedia inquiry to the target object based on the question-and-answer pair in response to determining that the question-and-answer pair is stored.

Clause 9: The method of Clause 8, wherein the question and answer pair comprises necessary information corresponding to an execution of the predetermined task.

Clause 10: The method of Clause 1, wherein initiating the multimedia inquiry to the target object comprises: obtaining historical behavior data of the target object; and generating the multimedia inquiry corresponding to the target object according to the historical behavior data.

Clause 11: The method of Clause 1, wherein the multimedia inquiry comprises at least one of: a text inquiry, a voice inquiry, an image inquiry, or a video inquiry.

Clause 12: A task processing device comprising a processor and memory configured to store processor executable instructions, the processor executing the instructions to implement: initiating a multimedia inquiry to a target object; obtaining response data in response to the multimedia inquiry; iteratively initiating one or more inquiries to obtain data for performing a predetermined task; and initiating the predetermined task based on the obtained data.

Clause 13: The device of Clause 12, wherein the processor iteratively initiating the one or more inquiries to obtain the data for performing the predetermined task comprises: obtaining the response data; determining whether the response data includes all the data for performing the predetermined task; determining missing data item(s) in response to determining that not all the data is included; and initiating a multimedia inquiry to the target object based on the determined missing data item(s) to obtain the data for performing the predetermined task.

Clause 14: The device of Clause 12, wherein the processor initiating the multimedia inquiry to the target object comprises: determining identity information of the target object; and initiating the multimedia inquiry corresponding to the identity information.

Clause 15: The device of Clause 14, wherein the processor determining the identity information of the target object comprises determining the identity information of the target object by obtaining image data and/or sound data of the target object.

Clause 16: The device of Clause 12, wherein the processor initiating the multimedia inquiry to the target object comprises: detecting whether the target object is present in a predetermined location area of the device; determining whether the target object is facing the device and stays for a time period that exceeds a predetermined time duration in response to determining that the target object is present; and initiating the multimedia inquiry to the target object in response to determining that the target object is facing the device and stays for the time period that exceeds the predetermined time duration.

Clause 17: The device of Clause 16, wherein the processor detecting whether the target object exists in the predetermined location area of the device comprises detecting whether the target object exists in the predetermined location area of the device by at least one of: a human body sensor, an infrared sensor, or a ground pressure sensor.

Clause 18: The device of Clause 12, wherein the processor initiating the multimedia inquiry to the target object comprises: determining whether a question-and-answer pair is stored; and initiating the multimedia inquiry to the target object based on the question-and-answer pair in response to determining that the question-and-answer pair is stored.

Clause 19: The device of Clause 18, wherein the question and answer pair comprises necessary information corresponding to an execution of the predetermined task.

Clause 20: The device of Clause 12, wherein the processor initiating the multimedia inquiry to the target object comprises: obtaining historical behavior data of the target object; and generating the multimedia inquiry corresponding to the target object according to the historical behavior data.

Clause 21: The device of Clause 12, wherein the multimedia inquiry comprises at least one of: a text inquiry, a voice inquiry, an image inquiry, or a video inquiry.

Clause 22: A computer readable media having computer instructions stored therein, the instructions that, when executed, implement the method of any one of Clauses 1-11.

What is claimed is:

1. A method implemented by one or more computing devices, the method comprising:
initiating a multimedia inquiry to a target object;
obtaining response data in response to the multimedia inquiry;
iteratively initiating one or more inquiries to obtain data for performing a predetermined task; and
initiating the predetermined task based on the obtained data.

2. The method of claim 1, wherein iteratively initiating the one or more inquiries to obtain the data for performing the predetermined task comprises:
obtaining the response data;
determining whether the response data includes all the data for performing the predetermined task;
determining missing data item(s) in response to determining that not all the data is included;
initiating a multimedia inquiry to the target object based on the determined missing data item(s) to obtain the data for performing the predetermined task.

3. The method of claim 1, wherein initiating the multimedia inquiry to the target object comprises:
determining identity information of the target object; and
initiating the multimedia inquiry corresponding to the identity information.

4. The method of claim 3, wherein the identity information comprises at least one of: an age or a gender.

5. The method of claim 3, wherein determining the identity information of the target object comprises determining the identity information of the target object by obtaining image data and/or sound data of the target object.

6. The method of claim 1, wherein initiating the multimedia inquiry to the target object comprises:
detecting whether the target object is present in a predetermined location area of the device;
determining whether the target object is facing the device and stays for a time period that exceeds a predetermined time duration in response to determining that the target object is present; and
initiating the multimedia query to the target object in response to determining that the target object is facing the device and stays for the time period that exceeds the predetermined time duration.

7. The method of claim 6, wherein detecting whether the target object exists in the predetermined location area of the device comprises detecting whether the target object exists in the predetermined location area of the device by at least one of: a human body sensor, an infrared sensor, or a ground pressure sensor.

8. The method of claim 1, wherein initiating the multimedia inquiry to the target object comprises:
determining whether a question-and-answer pair is stored; and
initiating the multimedia inquiry to the target object based on the question-and-answer pair in response to determining that the question-and-answer pair is stored.

9. The method of claim 8, wherein the question and answer pair comprises necessary information corresponding to an execution of the predetermined task.

10. The method of claim 1, wherein initiating the multimedia inquiry to the target object comprises:
obtaining historical behavior data of the target object; and
generating the multimedia inquiry corresponding to the target object according to the historical behavior data.

11. The method of claim 1, wherein the multimedia inquiry comprises at least one of:
a text inquiry, a voice inquiry, an image inquiry, or a video inquiry.

12. A device comprising: one or more processors; and memory coupled to the one or more processors and configured to store processor executable instructions that, when executed by the one or more processors, cause the one or more processors to perform acts comprising:
initiating a multimedia inquiry to a target object;
obtaining response data in response to the multimedia inquiry;
iteratively initiating one or more inquiries to obtain data for performing a predetermined task; and
initiating the predetermined task based on the obtained data.

13. The device of claim 12, wherein iteratively initiating the one or more inquiries until the data needed for performing the predetermined task is obtained comprises:
obtaining the response data;
determining whether the response data includes all the data for performing the predetermined task;
determining missing data item(s) in response to determining that not all the data is included; and
initiating a multimedia inquiry to the target object based on the determined missing data item(s) to obtain the data for performing the predetermined task.

14. The device of claim 12, wherein initiating the multimedia inquiry to the target object comprises:
determining identity information of the target object; and
initiating the multimedia inquiry corresponding to the identity information.

15. The device of claim 14, wherein determining the identity information of the target object comprises determining the identity information of the target object by obtaining image data and/or sound data of the target object.

16. The device of claim 12, wherein initiating the multimedia inquiry to the target object comprises:
detecting whether the target object is present in a predetermined location area of the device;
determining whether the target object is facing the device and stays for a time period that exceeds a predetermined time duration in response to determining that the target object is present; and
initiating the multimedia inquiry to the target object in response to determining that the target object is facing the device and stays for the time period that exceeds the predetermined time duration.

17. The device of claim 16, wherein detecting whether the target object exists in the predetermined location area of the device comprises detecting whether the target object exists in the predetermined location area of the device by at least one of: a human body sensor, an infrared sensor, or a ground pressure sensor.

18. The device of claim 12, wherein initiating the multimedia inquiry to the target object comprises:
determining whether a question-and-answer pair is stored; and
initiating the multimedia inquiry to the target object based on the question-and-answer pair in response to determining that the question-and-answer pair is stored.

19. The device of claim 12, wherein initiating the multimedia inquiry to the target object comprises:
obtaining historical behavior data of the target object; and
generating the multimedia inquiry corresponding to the target object according to the historical behavior data.

20. One or more computer readable media storing executable instructions that, when executed by one or more processors, cause the one or more processors to perform acts comprising:
initiating a multimedia inquiry to a target object;
obtaining response data in response to the multimedia inquiry;
iteratively initiating one or more inquiries to obtain data for performing a predetermined task; and
initiating the predetermined task based on the obtained data.
